(19) United States
(12) Patent Application Publication
(10) Pub. No.: US 2026/0257428 A1
(43) Pub. Date: Sep. 3, 2026

(54) MULTI-DIMENSIONAL PRINTING WITH ROBOTIC ARM

(71) Applicant: INTERNATIONAL BUSINESS MACHINES CORPORATION, Armonk, NY (US)

(72) Inventors: Martin G. Keen, Cary, NC (US); Aaron Keith Baughman, Cary, NC (US); Sarbajit Kumar Rakshit, Kolkata (IN); Carolina Garcia Delgado, Jalisco (MX)

(21) Appl. No.: 19/066,846

(22) Filed: Feb. 28, 2025

(51) Int. Cl. B29C 64/393; B29C 64/209; B33Y 30/00; B33Y 50/02

(52) U.S. Cl. CPC B29C 64/393; B29C 64/209; B33Y 30/00; B33Y 50/02

(57) ABSTRACT

Embodiments determine a shape of an object to be printed in a robotic system by analyzing a digital model of the object to be printed; determine an angle at which a printing nozzle approaches each individual layer of the object during a printing process based on the analyzed digital model and an analysis of a printing nozzle of the robotic system; determine a locus of movement of the printing nozzle and a locus of movement of a robotic arm of the robotic system; aggregate an intersection of the locus of movement of the robotic arm with the locus of movement of the printing nozzle; attach a printing bed to the robotic arm based on the aggregation of the intersection; and perform multi-dimensional printing of the object by utilizing the printing bed and the robotic arm of the robotic system.

### BACKGROUND

Aspects of the present invention relate generally to a system and a method for multi-dimensional printing.

Multi-dimensional printing, such as five dimensional (5D) printing or greater dimensions than 5D printing, is an emerging manufacturing technology that builds on a foundation of additive manufacturing such as three dimensional (3D) printing. In particular, multi-dimensional printing, such as 5D printing or greater dimensions than 5D printing, creates complex shaped objects.

### SUMMARY

In a first aspect of the invention, there is a method including: determining a shape of an object to be printed in a robotic system by analyzing a digital model of the object to be printed; determining an angle at which a printing nozzle approaches each individual layer of the object during a printing process based on the analyzed digital model and an analysis of the printing nozzle of the robotic system; determining a locus of movement of the printing nozzle and a locus of movement of a robotic arm of the robotic system; aggregating an intersection of the locus of movement of the robotic arm with the locus of movement of the printing nozzle; attaching a printing bed to the robotic arm based on the aggregation of the intersection; and performing multi-dimensional printing of the object by utilizing the printing bed and the robotic arm of the robotic system.

In another aspect of the invention, there is a computer program product including one or more computer readable storage media and program instructions stored on the one or more computer readable storage media to perform operations including: determining a shape of an object to be printed in a robotic system by analyzing a digital model of the object to be printed; determining an angle at which a printing nozzle approaches each individual layer of the object during a printing process based on the analyzed digital model and an analysis of the printing nozzle of the robotic system; determining a locus of movement of the printing nozzle and a locus of movement of a robotic arm of the robotic system; aggregating an intersection of the locus of movement of the robotic arm with the locus of movement of the printing nozzle; attaching a printing bed to the robotic arm based on the aggregation of the intersection; and performing multi-dimensional printing of the object by utilizing the printing bed and the robotic arm of the robotic system.

In another aspect of the invention, there is a system including a processor set, one or more computer readable storage media, and program instructions stored on the one or more computer readable storage media to cause the processor set to perform operations including: receiving a digital model of an object to be printed in a robotic system from an external application; determining a shape of the object to be printed in the robotic system by analyzing the digital model of the object to be printed; determining an angle at which a printing nozzle approaches each individual layer of the object during a printing process based on the analyzed digital model and an analysis of the printing nozzle of the robotic system; determining a locus of movement of the printing nozzle and a locus of movement of a robotic arm of the robotic system; aggregating an intersection of the locus of movement of the robotic arm with the locus of movement of the printing nozzle; attaching a printing bed to the robotic arm based on the aggregation of the intersection; and performing multi-dimensional printing of the object by utilizing the printing bed and the robotic arm of the robotic system.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

### DETAILED DESCRIPTION

Aspects of the present invention relate generally to a system and a method for multi-dimensional printing and more specifically, to utilizing a robotic arm as a multi-dimensional printing bed within a multi-dimensional printing platform. In further embodiments, the system includes a robotic system for multi-dimensional printing and includes a printing head, a robotic arm, and a printing bed. In aspects of the present invention, the printing head heats and extrudes a plastic filament through a printer nozzle to create a multi-dimensional object. In further aspects of the present invention, the printing bed is placed on the robotic arm of the robotic system. In embodiments of the present invention, the printing bed is a flat surface where the plastic filament is deposited to create the multi-dimensional object. Accordingly, implementations of the present invention create complex objects with higher strength and precision in comparison to conventional three dimensional (3D) printing methods.

Embodiments of the present invention allow for multi-dimensional printing for additional axes of movement of a printing bed simultaneously with movement of a printing head. In particular, aspects of the present invention provide a system, a computer program product, and a computer-implemented method to perform five dimensional (5D) printing by utilizing two more axes of movement for the printing bed in addition to the printing head which moves in X, Y, and Z directions. In further aspects of the present invention, the system, the computer program product, and the computer-implemented method has an expanded range of motion which allows for greater control over a printing process and enables creation of intricate designs. Embodiments of the present invention combine subtractive and additive techniques to create strong parts which are used in demanding applications and optimize design and performance. Further, although the present invention is described in terms of 5D printing, embodiments are not limited to 5D printing. Accordingly, aspects of the present invention can be applied to any multi-dimension printing which is greater than five dimensional (5D) printing.

Embodiments of the present invention create complex structures that require high strength and precision. Aspects of the present invention utilize complex axis movements and a combination of the subtractive and additive techniques. Accordingly, implementations of the present invention create intricately shaped, strong, and precise items for various industries such as orthopedic and dental surgery tools, automative industries, and aerospace industries.

Aspects of the present invention assess the degrees of freedom of different robotic arm bodies. Embodiments of the present invention determine whether any part of the robotic arm is capable of functioning as a printing bed for an object to be printed to achieve multi-dimensional printing capabilities. Further embodiments of the present invention allow the robotic arm to support 5D printing capabilities while concurrently performing assigned tasks.

Embodiments of the present invention equip different portions of the robotic arms with printing beds to allow for selection of a printing bed on a robotic arm based on requirements for 5D printing capabilities for a 3D object. Further, embodiments of the present invention allow a robotic system to perform 5D printing capability for the 3D object while performing other robotic tasks. Aspects of the present invention provide a first robotic system with a printing nozzle and a second robotic system with a printing bed attached to a robotic arm. Accordingly, implementations of the present invention utilize the first and second robotic systems to perform 5D printing capabilities while performing additional robotic tasks.

Aspects of the present invention utilize a multi-robotic ecosystem to identify robotic activities and printing objects (e.g., 3D objects) which are necessary for a robotic system to perform specific tasks. Accordingly, embodiments of the present invention optimize both robotic activities and printing activities of objects by leveraging 5D printing capabilities.

Embodiments of the present invention execute various types of arm movements based on different portions of a robotic arm of a robotic system. In this scenario, aspects of the present invention utilize specific arm movements for 5D printing in collaboration with multiple robotic units. Accordingly, implementations of the present invention synchronize the robotic activities and the 5D printing process to optimize the robotic tasks and the 5D printing operations.

Embodiments of the present invention provide a computer-implemented method, a system, and a computer program product for creating complex shaped objects with improved strength and precision in comparison to traditional printing methods. In contrast, conventional systems typically manufacture objects using 3D printing, which is a printing process that produces simple geometries and potentially brittle parts. Further, conventional systems utilizing 3D printing of objects result in 3D objects which may have a low service life. In addition, conventional systems utilizing 5D printing are expensive and require specialized parts.

Embodiments of the present invention include a system, method, and computer program product for printing in at least 5D by utilizing robotic arms as printing beds. Accordingly, implementations of the present invention provide an improvement (i.e., technical solution) to a problem arising in the technical field of printing multi-dimensional objects. In particular, embodiments of the present invention utilize 5D printing processes to create lightweight and durable objects which have complex shapes and improved strength. Further, embodiments of the present invention re-purpose robotic arms as printing beds to be utilized with a printing nozzle to provide a 5D printing process for printing complex and durable objects. Accordingly, aspects of the present invention provide cheaper 5D printing by re-purposing existing robotic arms to create complex and durable objects.

Implementations of the present invention are necessarily rooted in computer technology. For example, the steps of analyzing a printing nozzle of the robotic system to determine an angle at which the printing nozzle approaches each individual layer of the object during a printing process based on a digital model; attaching a printing bed to the robotic arm based on the aggregation of the intersection; and performing multi-dimensional printing of the object by utilizing the printing bed and the robotic arm of the robotic system cannot be performed in the human mind (or with pen and paper). Analyzing a printing nozzle of the robotic system to determine an angle at which the printing nozzle approaches each individual layer of the object during a printing process based on a digital model, attaching a printing bed to the robotic arm based on the aggregation of the intersection, and performing multi-dimensional printing of the object by utilizing the printing bed and the robotic arm of the robotic system is, by definition, performed by a computer, a robotic system, and a printing machine and cannot be performed in the human mind (or with a pen and paper).

Aspects of the present invention include a method, system, and computer program product for performing a 5D printing process of an object by utilizing a robotic arm. For example, a computer-implemented method includes: assessing degrees of freedom for different robotic arms; and determining whether the robotic arms are configured as a printing bed for an object to be printed. In further embodiments, the computer-implemented method selecting the printing bed of one of the robotic arms which satisfies requirements for printing the object by utilizing 5D printing capabilities. The computer-implemented method further comprises utilizing a printing nozzle with one of the robotic arms to perform 5D printing of the object to be printed. Embodiments of the computer-implemented method further comprises optimizing both 5D printing capabilities of the robotic arm and robotic task activities of the robotic arm. The computer-implemented method further comprises synchronizing a 5D printing process with robotic task activities of the robotic arm by utilizing different portions of the robotic arm.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as multi-dimensional printing code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

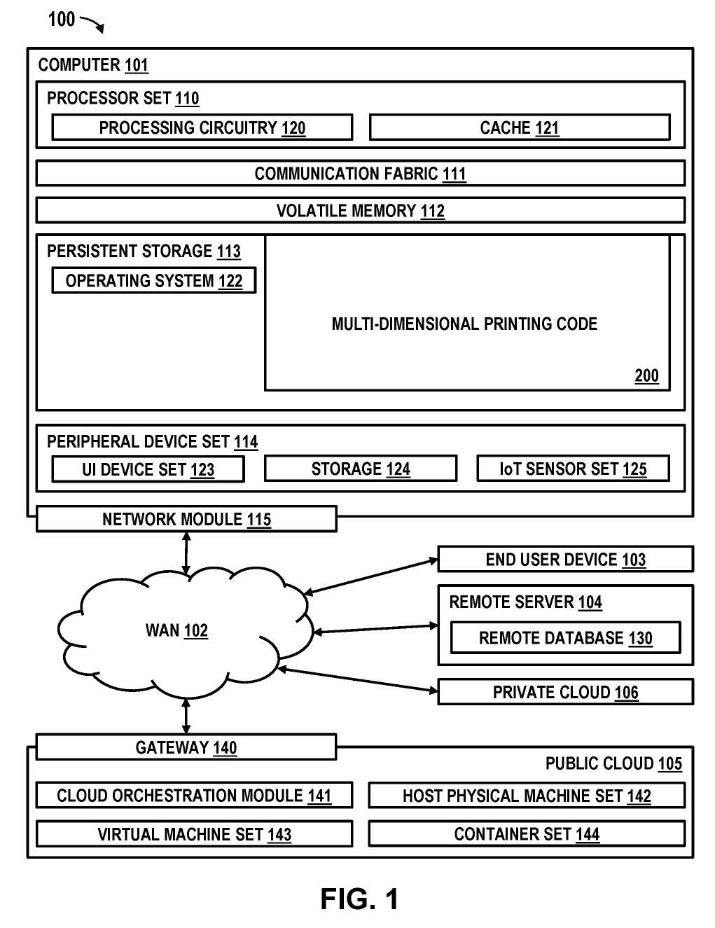

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

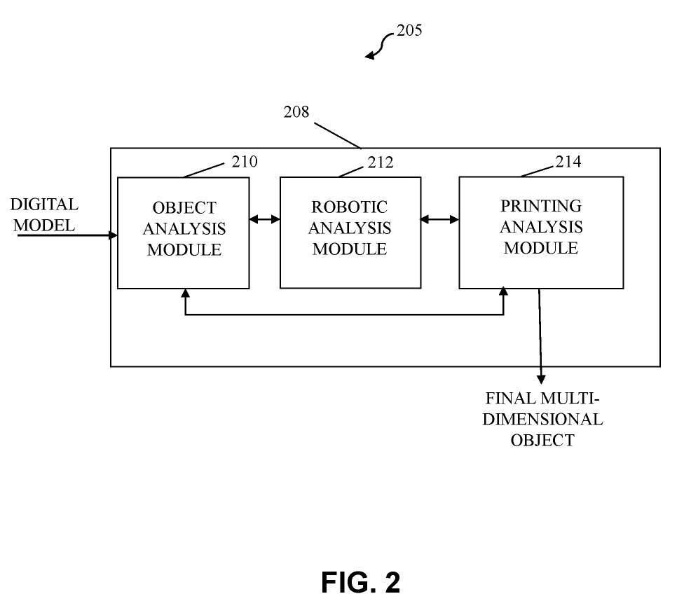

FIG. 2 shows a block diagram of an exemplary environment 205 in accordance with aspects of the present invention. In embodiments, the environment 205 includes a multi-dimensional printing server 208, which may comprise one or more instances of the computer 101 of FIG. 1. In other examples, the multi-dimensional printing server 208 comprises one or more virtual machines or one or more containers running on one or more instances of the computer 101 of FIG. 1.

In embodiments, the multi-dimensional printing server 208 of FIG. 2 comprises an object analysis module 210, a robotic analysis module 212, and a printing analysis module 214, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the present invention as described herein. These modules of the code of block 200 are executable by the processing circuitry 120 of FIG. 1 to perform the inventive methods as described herein. The multi-dimensional printing server 208 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In embodiments, the object analysis module 210 receives a digital model of an object from an external application. In further embodiments, the external application comprises a computer aided design (CAD) application. In embodiments of the present invention, the CAD application interprets and visualizes multi-dimensional structures. In other embodiments of the present invention, the CAD application interprets and visualizes a 3D digital model of the object. In aspects of the present invention, the object analysis module 210 analyzes the digital model of the object to determine overall dimensions, shape complexity, and any intricate features or overhangs that may require special printing techniques.

In aspects of the present invention, the object analysis module 210 analyzes a printing nozzle to break down the digital model of the object into individual layers and identify thickness of the individual layers. In embodiments, the object analysis module 210 also identifies areas of the digital model of the object that need support structures and identifies complex geometries that need support to prevent collapsing during a printing process. In further embodiments, the object analysis module 210 also determines an optimal orientation for the printing nozzle relative to the object. In particular, the object analysis module 210 analyzes the digital model of the object to determine an angle at which the printing nozzle approaches each individual layer of the object during the printing process. In further embodiments, the object analysis module 210 determines the angle at which the printing nozzle approaches each individual layer of the object based on several factors, including achieving a desired surface finish, minimizing overhands, and reducing a need for support structures.

In embodiments, the object analysis module 210 utilizes multi-dimensional printing simulation software to visualize the printing process and identify any potential issues with printing nozzle orientation. In particular, the object analysis module 210 utilizes a computer-aided design (CAD) and/or a computer-aided engineering (CAE) software to visualize the printing process and allow a user to identify potential issues with the printing nozzle orientation. Accordingly, the object analysis module 210 may change the printing nozzle orientation based on the user identifying potential issues with the printing nozzle orientation. In aspects of the present invention, the object analysis module 210 utilizes the multi-dimensional printing simulation software to optimize the printing nozzle orientation for each individual layer of the object during the printing process. In further embodiments of the present invention, optimizing the printing nozzle orientation for each individual layer of the object during the printing process may require several iterations and adjustments to optimize.

In aspects of the present invention, the object analysis module 210 develops a printing strategy that includes a direction the printing nozzle should move in each layer of the object based on the overall dimensions, the shape, the complexity, any intricate features or overhangs of the digital model of the object. In further embodiments, the object analysis module 210 also develops the printing strategy that includes the direction the printing nozzle should move in each layer of the object based on other factors, such as printing from a bottom-up process, printing from a top-down process, using infill patterns, and adjusting layer heights. For example, the printing strategy may also include how the printing nozzle is moving to print different portions of the object.

In embodiments, the object analysis module 210 utilizes printing simulation methods to simulate the printing process, including printing nozzle movement and material deposition. In further embodiments, the object analysis module 210 utilizes the CAD and/or the CAE software to simulate the printing process and allow a user to identify potential issues for further adjustments. Accordingly, the object analysis module 210 may make further adjustments based on the user identifying potential issues with the simulated printing process. In aspects of the present invention, the object analysis module 210 utilizes the multi-dimensional printing simulation software to visualize the simulated printing process and make further adjustments.

In embodiments of the present invention, the object analysis module 210 analyzes a printing nozzle movement profile while printing the object. In further embodiments, the object analysis module 210 identifies a relative nozzle movement from time to time to print the object based on the analysis of the printing nozzle movement profile while printing the object. In aspects of the present invention, the object analysis module 210 identifies the relative nozzle movement which includes a locus of the printing nozzle and a speed of movement of a robotic arm while printing the object. In further embodiments of the present invention, the object analysis module 210 sends the overall dimensions, the shape complexity, any intricate features or overhangs, the angle at which the printing nozzle approaches each individual layer of the object, the direction the printing nozzle should move in each layer of the object, the locus of the printing nozzle, and the speed of movement of the robotic arm to the robotic analysis module 212.

In embodiments, the robotic analysis module 212 identifies assigned tasks and activities for a robotic system. In aspects of the present invention, the assigned tasks and activities represent tasks and activities that are planned to be performed regardless of whether multi-dimensional printing is taking place. In further aspects of the present invention, the robotic system is configured to simultaneously perform multi-dimensional printing and the assigned tasks and activities. In further embodiments, the robotic analysis module 212 identifies how the robotic system performs the assigned tasks and activities. In particular, the robotic analysis module 212 analyzes a robotic arm movement of the robotic system to determine how different portions of a robotic arm performs movement while executing the assigned tasks and activities. In embodiments, the robotic analysis module 212 also gathers detailed information about a design of the robotic arm, including a type of the robotic arm (e.g., serial robotic arm, parallel robotic arm, etc.), a number of degrees of freedom (DoF), and types of joints (e.g., revolute, prismatic, etc.). For example, a revolute joint comprises a robotic joint with only one degree of freedom. In another example, a prismatic joint comprises a robotic joint that allows for linear motion along a single axis. In further embodiments, the robotic analysis module 212 also gathers additional information about the design of the robotic arm including a physical structure of the robotic system, such as a number of link arrangements and a number of joints.

In further embodiments, the robotic analysis module 212 identifies the DoF of each joint in the robotic arm, including a range of motion and flexibility of each part of the robotic arm. The robotic analysis module 212 uses the DoF, the range of motion of the robotic arm, and the flexibility of the robotic arm to identify a kinematic chain and how each joint movement contributes to an overall arm movement. In aspects of the present invention, the kinematic chain represents a series of interconnected links and joints of the robotic arm that work together to transfer motion forces (e.g., an arm movement) within the robotic arm.

In aspects of the present invention, the robotic analysis module 212 also identifies a workspace and the assigned tasks and activities that the robotic arm is expected to perform. In further embodiments, the workspace is a region of space the robotic arm can reach. In aspects of the present invention, the robotic analysis module 212 identifies an end effector of the robotic arm, which includes a geometry and capability of the end effector. In embodiments, the end effector of the robotic arm comprises a device that attached to an end of the robotic arm to allow interaction with the environment. For example, the end effector can be one of a gripper, a sensor, or a processing tool.

In embodiments of the present invention, the robotic analysis module 212 performs kinematic analysis of the robotic arm to simulate and analyze a movement of different portions of the robotic arm. In further embodiments of the present invention, the kinematic analysis of the robotic arm includes analyzing dimensions and connectivity of kinematic chains and the position, velocity, and acceleration of each of the links in the robotic arm to plan and control movement and to compute actuator forces and torques. In further aspects of the present invention, the kinematic chain represents the assembly of links which are connected by joints to provide a constrained motion. In implementations of the present invention, the robotic analysis module 212 calculates forward kinematics to determine a position and orientation of the end effector based on joint angles. In aspects of the present invention, the forward kinematics represents joint parameters and computes a configuration of a chain. The robotic analysis module 212 also utilizes sensor feeds to perform inverse kinematics to find joint angles required to reach a specific position and orientation in space. In further embodiments, the inverse kinematics specifies an end-effector location and computes the associated joint angles.

In aspects of the present invention, the robotic analysis module 212 forecasts kinematic variables. In further embodiments of the present invention, the kinematic variables comprise position, velocity, acceleration, displacement, speed, time, initial velocity, and final velocity. In further embodiments of the present invention, the robotic analysis module 212 uses Runge-Kutta methods (i.e., RK4) to determine where the arm should move given rates of acceleration for fine tuning. In aspects of the present invention, the robotic analysis module 212 also utilizes polynomial forecasting for general tuning to determine where the arm should move given rates of acceleration.

In embodiments of the present invention, the robotic analysis module 212 analyze specific movements and tasks required for each assigned activity. In aspects of the present invention, the robotic analysis module 212 determines which joints and links of the robotic arm are involved in each activity. In further embodiments of the present invention, the robotic analysis module 212 identifies a sequence of movements, including joint angles and trajectories, to perform each task accurately.

In aspects of the present invention, the robotic analysis module 212 creates visual representations, such as 3D models or diagrams, to illustrate a locus of movements for different portions of the robotic arm. In further embodiments of the present invention, the robotic analysis module 212 sends the information on how different portions of the robotic arm perform movements while performing any assigned activity and the loci of movement of different portions of the robotic arm and the printing nozzle to the printing analysis module 214.

In embodiments of the present invention, the printing analysis module 214 gathers data on movement paths of both the printing nozzle and the robotic arm during the assigned activity associated with the robotic arm. In further embodiments of the present invention, the printing analysis module 214 converts the data on the movement paths of the printing nozzle and the robotic arm into a common format for analysis. In particular, the printing analysis module 214 converts the data on the movement paths of the printing nozzle and the robotic arm into a 3D coordinate system. In further embodiments, the printing analysis module 214 converts the data on the movement paths of the printing nozzle and the robotic arm into the common format while also synchronizing the data in time by aligning starting points and timestamps. In aspects of the present invention, the printing analysis module 214 divides the data on the movement paths of the printing nozzle and the robotic arm into segments or discrete steps based on the assigned activities associated with the robotic arm. For example, the printing analysis module 214 segments the data on the movement paths of the printing nozzle and the robotic arm into individual layers or robotic arm tasks. In embodiments of the present invention, the printing analysis module 214 normalizes the scale and orientation of the data of the movement paths of the printing nozzle and the robotic arm for performing comparison analysis. For example, the printing analysis module 214 scales or transforms the data of the movement paths of the printing nozzle and the robotic arm to ensure that the data of the movement paths of the printing nozzle and the robotic arm is within a same reference frame.

In aspects of the present invention, the printing analysis module 214 extracts relevant features from the data on the movement paths of the printing nozzle and the robotic arm to capture key characteristics. In particular, key characteristics include printing nozzle characteristics such as path length, printing speed, and layer thickness of the printing nozzle. Further, key characteristics also include robotic arm characteristic such as joint angles, end-effector position, and orientation of the robotic arm. In embodiments of the present invention, the printing analysis module 214 aligns the printing nozzle characteristics with the robotic arm characteristics. In aspects of the present invention, the printing analysis module 214 utilizes registration techniques such as point cloud registration or transformation algorithms to achieve the alignment of the printing nozzle characteristics with robotic arm characteristics. In embodiments of the present invention, a point cloud registration captures a first set of data points which correspond to the printing nozzle characteristics in a first cloud and captures a second set of data points which correspond to the robotic arm characteristics in a second cloud. In further embodiments, the point cloud registration comprises aligning two or more clouds (e.g., aligning the first cloud with the second cloud) together to build one big cloud in which the first set of data points are aligned with the second set of data points within a common coordinate system. In further aspects of the present invention, the transformation algorithms comprise an algorithm which utilizes mathematical transformations to align data points or sequences.

In embodiments of the present invention, the printing analysis module 214 determines comparison metrics by quantitatively analyzing the movement paths of the printing nozzle and the robotic arm to assess similarity or dissimilarity of each movement path of the printing nozzle and the robotic arm. In particular, the printing analysis module 214 establishes threshold values or threshold criteria for determining the comparison metrics by quantitively analyzing whether the movements paths of the printing nozzle and the robotic arm are similar or dissimilar.

In aspects of the present invention, the printing analysis module 214 utilizes the comparison metrics to identify the movement path of the printing nozzle which is similar to the movement path of the robotic arm. The printing analysis module 214 identifies whether any optimization can be performed on the robotic arm movement based on the comparison metrics. In further embodiments, the printing analysis module 214 also analyzes and determines an intersection of the locus of movement of the robotic arm with the locus of movement of the printing nozzle. The printing analysis module 214 utilizes the optimization that can be performed on the robotic arm movement and the intersection of the locus of movement of the robotic arm with the locus of movement of the printing nozzle to simulate a printing process. In embodiments, the printing analysis module 214 aggregates the intersection of the locus of movement of the robotic arm with the locus of movement of the printing nozzle to compare with the simulated printing process and a robotic activity based on a trial and error method. In further embodiments, the printing analysis module 214 identifies portions where multi-dimensional (e.g., 5D printing) can be utilized based on the aggregation of the intersection of the locus of movement of the robotic arm with the locus of movement of the printing nozzle and the simulated printing process. In aspects of the present invention, the printing analysis module 214 identifies a priority between a robotic activity and the printing process. The printing analysis module 214 also identifies which robotic arm can provide mobility usable to perform multi-dimensional printing (e.g., performing 5D printing).

In embodiments of the present invention, the printing analysis module 214 attaches a printing bed to the robotic arm based on the optimization that can be performed on the robotic arm movement and the aggregation of the intersection of the locus of movement of the robotic arm with the locus of movement of the printing nozzle. In an aspect of the present invention, the printing analysis module 214 utilizes another robotic arm to attach the printing bed to the robotic arm. In other embodiments, the printing analysis module 214 utilizes a specialized grabber device to attach the printing bed to the robotic arm. In further embodiments of the present invention, the printing analysis module 214 utilizes a printer or another printing nozzle attached to another robot to perform the robotic activity based on the movement of the robotic arm. For example, the printing analysis module 214 utilizes the printer or the another printing nozzle attached to another robot to perform 3D printing on the printing bed attached to the robotic arm. In aspects of the present invention, the printing analysis module 214 performs multi-dimension printing (e.g., 5D printing) on the printing bed attached to the robotic arm based on the optimization that can be performed on the robotic arm movement and the aggregation of the intersection of the locus of movement of the robotic arm with the locus of movement of the printing nozzle to create a final multi-dimension object. In further embodiments of the present invention, the printing analysis module 214 outputs the final multi-dimension object based on the multi-dimension printing (e.g., 5D printing).

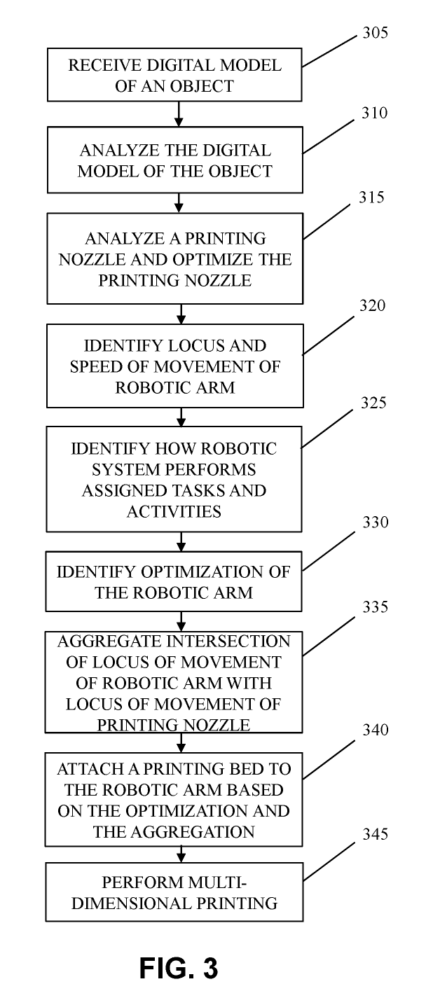

FIG. 3 shows a flowchart of an exemplary method in accordance with aspects of the present invention. Steps of the method may be carried out as operations in the environment 205 of FIG. 2 and are described with reference to elements depicted in FIG. 2.

At step 305, the system receives, at the object analysis module 210, a digital model of an object from an external application. In embodiments and as described with FIG. 2, the external application comprises a computer aided design (CAD) application. At step 310, the system analyzes, at the object analysis module 210, the digital model of the object to determine overall dimensions, shape complexity, and any intricate features or overhands that may require special printing techniques. At step 315, the system analyzes, at the object analysis module 210, a printing nozzle to break down the digital model of the object into individual layers and identify thickness of the individual layers and optimizes the printing nozzle. In embodiments and as described with FIG. 2, the object analysis module 210 determines an angle at which the printing nozzle approaches each individual layer of the object during a printing process. In further embodiments, the object analysis module 210 utilizes multi-dimensional printing simulation software to optimize the printing nozzle orientation for each individual layer of the object during the printing process.

At step 320, the system identifies, at the object analysis module 210, a locus of the printing nozzle and a speed of movement of a robotic arm. At step 325, the system identifies, at the robotic analysis module 212, how the robotic system performs the assigned tacks and activities. At step 330, the system identifies, at the printing analysis module 214, an optimization of the robotic arm. At step 335, the system aggregates, at the printing analysis module 214, a locus of movement of the robotic arm with a locus of movement of the printing nozzle. At step 340, the system attaches, at the printing analysis module 214, a printing bed to the robotic arm based on the optimization of the robotic and the aggregation of the locus of movement of the robotic arm with the locus of movement of the printing nozzle. At step 345, the system performs, at the printing analysis module 214, a multi-dimension printing. In embodiments and as described with FIG. 2, the system performs the multi-dimension printing by performing 5D printing.

In a first exemplary use case, a robotic system includes a robotic arm which includes a first rotational axis, a second rotational axis, a third rotational axis, a fourth rotational axis, a fifth rotational axis, and a sixth rotational axis. Accordingly, the robot arm has six degrees of freedom (DoF).

In the first exemplary use case, the DoF refers to a number of independent parameters or directions in which the arm can move or rotate. In the first exemplary use case, each degree of freedom represents one independent motion or rotational axis. Further, implementations of the present invention include robotic arms which have varying degrees of freedom, and the number of DoF affects the range of motions and capabilities. For example, four DoF adds a capability for pitch or yaw in relation to three degrees of freedom and is suitable for tasks requiring orientation adjustments (e.g., painting). In embodiments, five DoF adds one more rotational axis (e.g., a wrist joint) to four DoF, orients the robotic arm to the end-effector in a different direction, and is utilized for tasks such as a welding or machining. In further embodiments, six DoF provides full positioning and orientation control, mimics the movements of a human arm with a shoulder, an elbow, a wrist, and hand motions, and is utilized for complex tasks, including surgical robots and advanced manufacturing. In aspects of the present invention, seven DoF typically includes finger articulation, allowing for dexterous manipulation, and is utilized for highly specialized tasks or advanced robotic arms. In embodiments of the present invention, a choice of a number of DoF in the robotic arm depends on specific application and tasks that need to be performed. In further embodiments of the present invention, an increased number of DoF provides greater flexibility. The design of the robotic arm can be changed to meet different requirements, from simple pick and place operations to complex tasks like surgical operations or space exploration.

In a second exemplary use case, a printing bed is attached to a robotic system to configure the robotic system for multi-dimensional printing capability (e.g., 5D printing capability). In the second exemplary use case, the printing bed is attached to a robotic arm of the robotic system. Accordingly, the robotic system with the printing bed attached to the robotic arm of the robotic system allows for multi-dimensional printing capability (e.g., 5D printing capability). In further embodiments, the robotic system can move while still performing multi-dimensional printing of an object (e.g., 5D printing of the object). In this embodiment, a secondary robot can perform simultaneous 3D printing of another object (i.e., an assigned activity) while the robotic system performs multi-dimensional printing of the object.

In a third exemplary use case, a first robotic system includes a first axis, a second axis, a third axis, a fourth axis, a fifth axis, and a sixth axis. In the third exemplary use case, a second robotic system includes a first axis, a second axis, a third axis, a fourth axis, a fifth axis, a sixth axis, and a seventh axis.

In the third exemplary use case, the robotic analysis module 212 (as described in FIG. 2) determines a locus of the first robotic system and the second robotic system. In the third exemplary use case, the robotic analysis module 212 determines the locus of movements of the first robotic system and the second robotic system while performing assigned tasks and activities. In the third exemplary use case, the robotic analysis module 212 also determines relative movements of the first robotic system in comparison to the second robotic system while performing the assigned tasks and the activities. In embodiments of the present invention, the robotic analysis module 212 also determines movements of a same local arm region across the first robotic system and the second robotic system while performing the assigned tasks and the activities. For example, the assigned tasks and activities can include attaching the printing bed on one of the robotic arms of the first robotic system and the second robotic system.

In a fourth exemplary use case, the robotic analysis module 212 (as described in FIG. 2) creates visual representations, such as a 3D graph of a locus of movements for a first robotic system and a second robotic system. In particular, the 3D graph plots locus of movements of the first robotic system and the second robotic system in three dimensions (i.e., in X, Y, and Z axis). In embodiments of the present invention, the second robotic system utilizes a second robotic arm to attach a printing bed to a first robotic arm of the first robotic system. Accordingly, the locus of movements of the second robotic system utilizing the second robotic arm to attach the printing bed to the first robotic arm of the first robotic system and the movement of the first robotic arm after the printing bed is attached can be included in the 3D graph.

In still additional embodiments, the present invention provides a computer-implemented method, via a network. In this case, a computer infrastructure, such as computer 101 of FIG. 1, can be provided and one or more systems for performing the processes of the present invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
determining a shape of an object to be printed in a robotic system by analyzing a digital model of the object to be printed;
determining an angle at which a printing nozzle approaches each individual layer of the object during a printing process based on the analyzed digital model and an analysis of the printing nozzle of the robotic system;
determining a locus of movement of the printing nozzle and a locus of movement of a robotic arm of the robotic system;
aggregating an intersection of the locus of movement of the robotic arm with the locus of movement of the printing nozzle;
attaching a printing bed to the robotic arm based on the aggregation of the intersection; and
performing multi-dimensional printing of the object by utilizing the printing bed and the robotic arm of the robotic system.

2. The method of claim 1, further comprising receiving the digital model of the object from an external application.

3. The method of claim 2, wherein the external application comprises a computer aided design (CAD) software which interprets and visualizes multi-dimensional structures.

4. The method of claim 3, wherein the digital model is a multi-dimensional structure of the object.

5. The method of claim 1, further comprising analyzing the printing nozzle to separate the digital model of the object into individual layers and thickness of the individual layers.

6. The method of claim 1, wherein the performing the multi-dimensional printing of the object comprises performing five dimensional (5D) printing of the object.

7. The method of claim 1, further comprising determining velocity, acceleration, and position of each link in the robotic arm.

8. The method of claim 7, further comprising tuning the robotic arm to determine where the robotic arm moves based on the acceleration by utilizing Runge-Kutta methods.

9. The method of claim 7, further comprising tuning the robotic arm to determine where the robotic arm moves based on the acceleration by utilizing polynomial forecasting.

10. The method of claim 1, further comprising optimizing a printing nozzle orientation of the printing nozzle for each individual layer of the object during the printing process by utilizing multi-dimensional printing simulation software.

11. The method of claim 1, further comprising determining a speed of movement of the robotic arm.

12. The method of claim 11, further comprising optimizing movement of the robotic arm based on the locus of movement of the robotic arm and the speed of movement of the robotic arm.

13. A computer program product comprising:
one or more computer readable storage media; and
program instructions stored on the one or more computer readable storage media to perform operations comprising:
determining a shape of an object to be printed in a robotic system by analyzing a digital model of the object to be printed;
determining an angle at which a printing nozzle approaches each individual layer of the object during a printing process based on the analyzed digital model and an analysis of the printing nozzle of the robotic system;
determining a locus of movement of the printing nozzle and a locus of movement of a robotic arm of the robotic system;
aggregating an intersection of the locus of movement of the robotic arm with the locus of movement of the printing nozzle;
attaching a printing bed to the robotic arm based on the aggregation of the intersection; and
performing multi-dimensional printing of the object by utilizing the printing bed and the robotic arm of the robotic system.

14. The computer program product of claim 13, further comprising receiving the digital
model of the object from an external application.

15. The computer program product of claim 14, wherein the external application
comprises a computer aided design (CAD) software which interprets and visualizes multi-dimensional structures.

16. The computer program product of claim 15, wherein the digital model is a multi-
dimensional structure of the object.

17. The computer program product of claim 13, wherein the performing the multi-dimensional printing of the object comprises performing five dimensional (5D) printing of the object.

18. The computer program product of claim 13, further comprising optimizing a printing nozzle orientation of the printing nozzle for each individual layer of the object during the printing process by utilizing multi-dimensional printing simulation software.

19. The computer program product of claim 13, further comprising:
determining a speed of movement of the robotic arm; and
optimizing movement of the robotic arm based on the locus of movement of the robotic arm and the speed of movement of the robotic arm.

20. A system comprising:
a processor set;
one or more computer readable storage media; and
program instructions stored on the one or more computer readable storage media to cause the processor set to perform operations comprising:
receiving a digital model of an object to be printed in a robotic system from an external application;
determining a shape of the object to be printed in the robotic system by analyzing the digital model of the object to be printed;
determining an angle at which a printing nozzle approaches each individual layer of the object during a printing process based on the analyzed digital model and an analysis of the printing nozzle of the robotic system;
determining a locus of movement of the printing nozzle and a locus of movement of a robotic arm of the robotic system;
aggregating an intersection of the locus of movement of the robotic arm with the locus of movement of the printing nozzle;
attaching a printing bed to the robotic arm based on the aggregation of the intersection; and
performing multi-dimensional printing of the object by utilizing the printing bed and the robotic arm of the robotic system.
